(19) United States
(12) Patent Application Publication
(10) Pub. No.: US 2004/0233512 A1
(43) Pub. Date: Nov. 25, 2004

(54) Light wavelength converter and method of manufacturing the same

(75) Inventors: Yoshiharu Fujioka, Ome-shi (JP); Ken Ito, Fukaya-shi (JP); Akio Onuki, Yokohama-shi (JP); Naomi Fujioka, Zama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/812,185

(22) Filed: Mar. 30, 2004

(30) Foreign Application Priority Data
May 20, 2003 (JP) 2003-141995

(51) Int. Cl. G02F 2/02

(52) U.S. Cl. 359/326

(57) ABSTRACT

A light wavelength converter including excitation medium doped with rare earth metals to convert wavelength of laser light incident upon excitation medium, including rectangular parallelepiped member comprising layered member in which excitation medium is stacked in films on first optical member having refractive index lower than that of excitation medium and having flat plate shape and in which second optical member having refractive index lower than that of excitation medium is stacked on stacked surface of first optical member, third and fourth optical members being bonded onto surfaces extending in parallel with a longitudinal direction of rectangular parallelepiped member and crossing stacked surface at right angles and having refractive index lower than that of excitation medium, and first and second reflective members being formed on the opposite end surfaces of rectangular parallelepiped member in the longitudinal direction to form laser resonator structure.

### CROSS-REFERENCE TO RELATED APPLICATIONS

This application is based upon and claims the benefit of priority from prior Japanese Patent Application No. 2003-141995, filed May 20, 2003, the entire contents of which are incorporated herein by reference.

### BACKGROUND OF THE INVENTION

1. Field of the Invention

The present invention relates to a light wavelength converter for obtaining visible rays or ultraviolet rays from a laser light by an upconversion technique, and a method of manufacturing the converter. The present invention particularly relates to a light wavelength converter for obtaining a high-output laser light, and a method of manufacturing the converter.

2. Description of the Related Art

A laser source device has been used in applications such as data read/write of an optical recording medium. Further in recent years, a high-output type light source device has been researched, and applications into a projection TV, liquid crystal projector, traffic signal and the like have been started to be studied. In these applications, an output light wavelength has been requested to be set optionally to a certain degree, but it is difficult to obtain a light in a short wavelength range directly from a laser source at a high output. To solve the problem, the output light wavelength of the laser source has been converted by an upconversion technique.

In upconvergence, an excitation light (e.g., infrared light) is introduced into optical mediums such as optical fibers to which lanthanum-based rare earth elements such as erbium (Er) and praseodymium (Pr) are added to excite a rare earth metal to a high-energy level. Moreover, the rare earth metal shifts to a stationary state to generate a laser light with a wavelength corresponding to a difference of the energy level, and the laser light is taken out in the technique. In accordance with this technique, infrared rays can be converted to short-wavelength lights such as visible rays in a blue region and ultraviolet rays.

Additionally, a width of an emission layer needs to be enlarged in a slow-axis direction in order to raise the output of a semiconductor laser source. Therefore, it has been known that asymmetry of a shape of a laser output light becomes remarkable. For example, the emitted shape of a high-output type infrared semiconductor laser spreads by 1 to 2 μm in a fast-axis direction, and spreads by about several hundreds of μms in the slow-axis direction, and the spread into the slow-axis direction is excessively broader than that into the fast-axis direction. On the other hand, a core diameter of an optical fiber for excitation is around 10 μm, and it is therefore very difficult to secure an optical coupling efficiency of both the light source and the fiber. With the use of a complicated optical system, even when the light source and fiber are positioned with a high precision, the coupling efficiency obtained by the existing technique is less than 10% at most.

Furthermore, a general material of the optical fiber for excitation is heavy metal fluoride glass having a small phonon energy. However, this glass is easily crystallized, and it is difficult to form the glass into the fiber. For a ZrF4-BaF2-LaF3-AlF3-NaF (ZBLAN) based glass which has been most studied for the use in this type of application, there are disadvantages that a weather resistance to humidity is bad and that a degree of change with elapse of time is large.

It is to be noted that related techniques are described in Jpn. Pat. Appln. KOKAI Publication Nos. 9-105965 and 7-333452. In accordance with the technique described in the Jpn. Pat. Appln. KOKAI Publication No. 9-105965, there are provided an optical amplifier which does not contain an alkali metal or an alkali earth metal, and glass for optical fibers. In the publication, a plane type optical waveguide structure doped with rare earth metals is described which is capable of obtaining a laser light in an infrared range of 1 to 2 nm for use in information communication. In the Jpn. Pat. Appln. KOKAI Publication No. 7-333452, the application into the upconvergence is not described, but an optical waveguide capable of reducing inner losses is described.

As described above, the existing upconversion technique has disadvantages that it is difficult to enhance the coupling efficiency to the fiber for excitation because or a remarkable flat shape of the high-output laser light and that the loss of energy is large. To enhance the coupling efficiency even a little, a complicated optical system using non-spherical lenses or a high-precision positioning control is required, and this also causes disadvantages that the size of a device increases and that a manufacturing yield is bad. Even when these countermeasures are implemented, the obtained coupling efficiency is about 10% at most, and there has been a demand for further technical improvement.

Furthermore, for the fluoride glass for use as a core material for upgrading emission efficiencies of rare earth metals, the countermeasures such as crystallization at a preparation time and mixture of bubbles need to be implemented, and laborious processes such as charging into nitrogen are required. This type of glass material is sensitive to humidity, and has disadvantages that a degree of change with an elapse of time is large.

### BRIEF SUMMARY OF THE INVENTION

According to an aspect of the present invention, there is provided a light wavelength converter including an excitation medium doped with rare earth metals to convert a wavelength of a laser light incident upon the excitation medium, comprises a rectangular parallelepiped member comprising a layered member in which the excitation medium is stacked in films on a first optical member having a refractive index lower than that of the excitation medium and having a flat plate shape and in which a second optical member having a refractive index lower than that of the excitation medium is stacked on the stacked surface of the first optical member; third and fourth optical members which are bonded onto surfaces extending in parallel with a longitudinal direction of the rectangular parallelepiped member and crossing the stacked surface at right angles and which have a refractive index lower than that of the excitation medium; and first and second reflective members which are formed on the opposite end surfaces of the rectangular parallelepiped member in the longitudinal direction to form a laser resonator structure.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an upconvergence optical waveguide 11 relating to a first embodiment of the present invention;

FIG. 2 is a diagram showing an emitted light end surface of a high-output type semiconductor laser 1;

FIG. 3 is a transverse sectional view showing a function principle of the upconvergence optical waveguide 11 of FIG. 1;

FIG. 4 is a diagram showing a stacked state of the core layer 12 in a predetermined thickness on the substrate 13;

FIG. 5 is a diagram showing a state in which the substrate 14 is superposed and bonded onto the stacked surface of the core layer 12 of the member 30;

FIG. 6 is a diagram showing that the member 31 is cut in a predetermined width t1 in a direction (horizontal direction in the figure) crossing a thickness direction of the member at right angles, and a member 33 having a rectangular parallelepiped shape is cut out;

FIG. 7 is a diagram showing a state in which the substrate 15 is bonded to the member 33;

FIG. 8 is a diagram showing a state in which the width of the core layer 12 is changed with respect to the member 33;

FIG. 9 is a diagram showing a state in which the substrate 16 is bonded to the member 36;

FIG. 10 is a flowchart showing a manufacturing process of the upconvergence optical waveguide 11 of FIG. 1;

FIG. 11 is a sectional view of the upconvergence optical waveguide 11 formed by the procedure of FIG. 10;

FIG. 12 is a diagram showing a conventional constitution for realizing upconvergence for comparison;

FIG. 13 is a schematic diagram showing a constitution of the optical fiber 5, 6;

FIG. 14 is a sectional view of the upconvergence optical waveguide 11 relating to the second embodiment;

FIG. 15 is a transverse sectional view showing the function principle of the upconvergence optical waveguide 11 of FIG. 14;

FIG. 16 is a diagram showing a third embodiment of the upconvergence optical waveguide relating to the present invention;

FIG. 17 is an XVII-XVII sectional view of the upconvergence optical waveguide of FIG. 16;

FIG. 18 is a diagram showing another example of the pattern of the core layer 12 in the third embodiment;

FIG. 19 is a diagram showing the upconvergence optical waveguide 11 relating to another embodiment of the present invention; and

FIG. 20 is a diagram showing the upconvergence optical waveguide 11 relating to another embodiment of the present invention.

### DETAILED DESCRIPTION OF THE INVENTION

Embodiments of the present invention will hereinafter be described with reference to the drawings.

(First Embodiment)

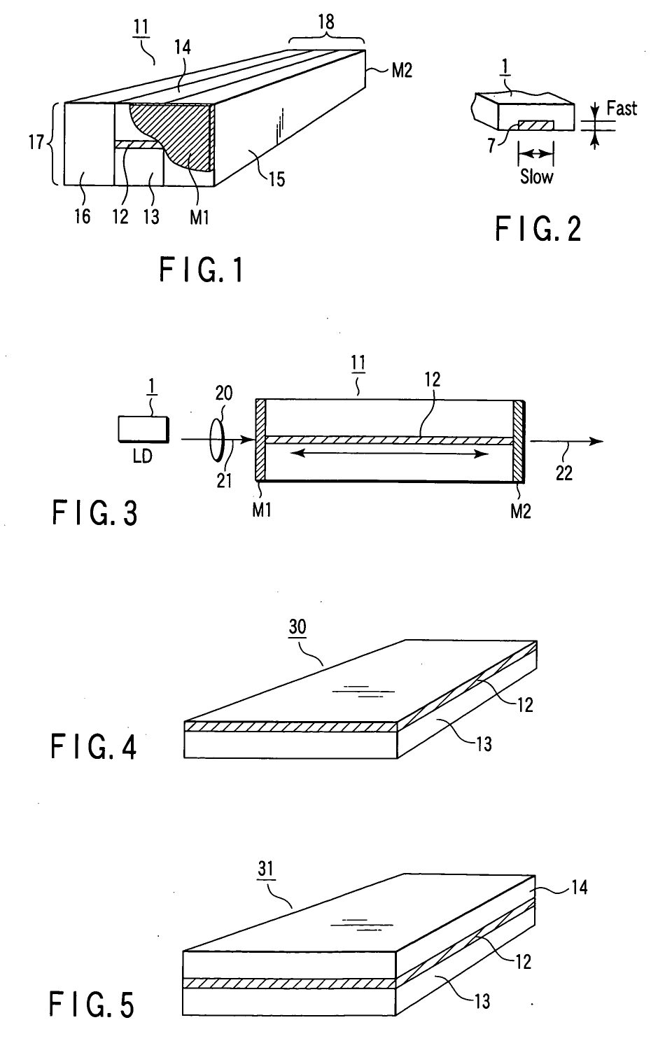

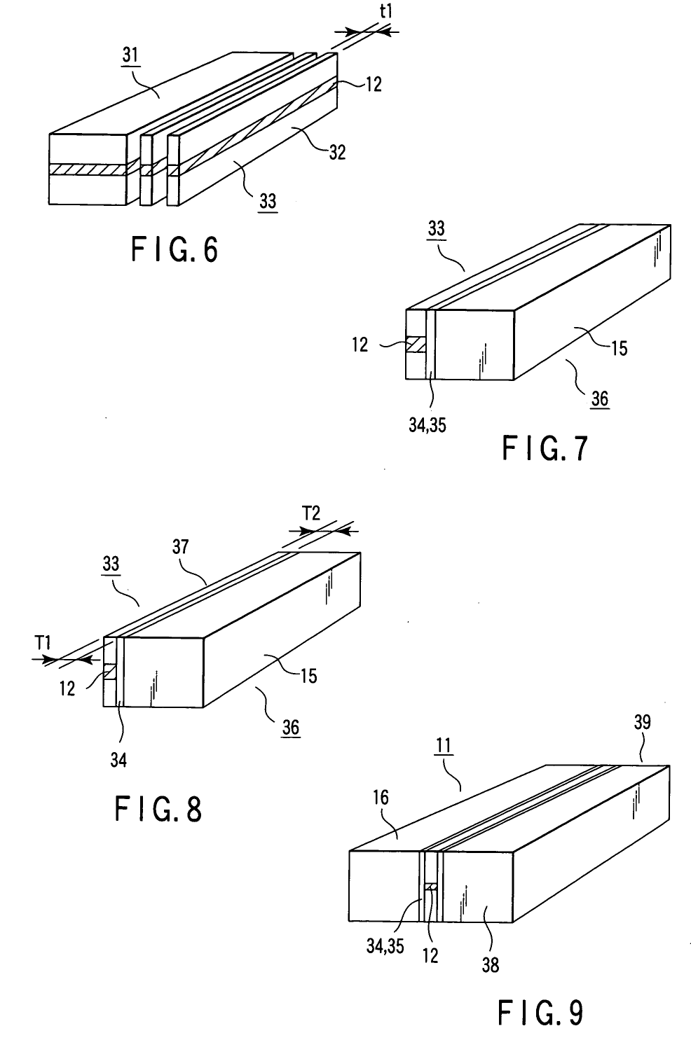

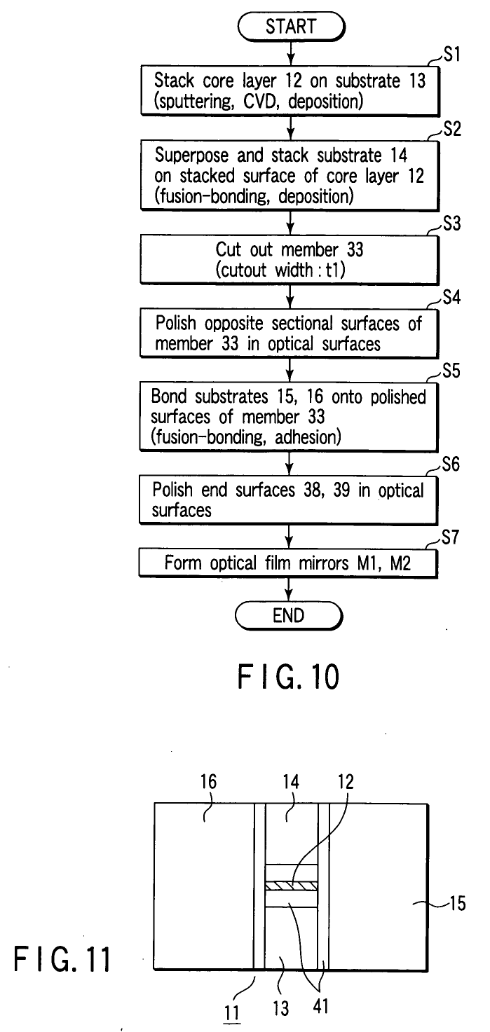

FIG. 1 is a perspective view showing an upconvergence optical waveguide 11 relating to a first embodiment of the present invention. The upconvergence optical waveguide 11 up-converts a laser light incident from a high-output type semiconductor laser (laser diode: hereinafter referred to as LD) inside an optical waveguide structure to emit a light having a wavelength shorter than that of the incident light. The upconvergence optical waveguide 11 is used in applications such as generation of an RGB light required for image display in projection television.

In FIG. 1, a core layer 12 is coated with substrates 13, 14, 15, 16 such as glass. The core layer 12 is formed by stacking a fluoride glass doped with rare earth metals such as Er, Pr, and ytterbium (Yb) in films on the substrate 13 by so-called thin-film forming techniques such as sputtering, CVD, and deposition. The substrates 14, 15, 16 are formed so as to cover the core layer 12 by the thin-film forming techniques or techniques such as fusion bonding and adhesion. Each of optical refractive indexes of the substrates 14, 15, 16 is smaller than that of the core layer 12. Accordingly, the core layer 12 is formed as a core clad with the substrates 13, 14, 15, 16 to form an optical waveguide structure.

Opposite ends of the upconvergence optical waveguide 11 are finished up to an optical polishing level. An optical film mirror M1 is formed on a laser incidence end 17, and an optical film mirror M2 is formed on a laser emission end 18. The optical film mirror M1 has a transmittance of 100% with respect to an incident infrared light, and has a reflectance of 100% with respect to a red or green light. The optical film mirror M2 has a transmittance of 5 to 90% with respect to the red or green light, and has a reflectance of 100% with respect to the infrared light. Either of the optical film mirrors M1, M2 is a so-called half mirror. Accordingly, a laser resonator is formed. The infrared light incident from the laser incidence end 17 is excited in the core layer 12 by the laser resonator, and the light whose wavelength is converted is outputted via the laser emission end 18.

FIG. 2 is a diagram showing an emitted light end surface of a high-output type semiconductor laser 1. In general, an emission layer 7 of the semiconductor laser has a thickness of several μms in a fast-axis direction, and has a width several times the thickness in a slow-axis direction. A spread of the emission layer 7 in the slow-axis direction increases with the increase of outputs of the semiconductor laser. In recent years, there has been an emission layer of an infrared laser having a thickness of 1 to 2 μm but having a width of several hundreds of μms. The laser incidence end 17 and core layer 12 of the upconvergence optical waveguide 11 of FIG. 1 can be formed in accordance with the flat shape of the emission layer.

FIG. 3 is a transverse sectional view showing a function principle of the upconvergence optical waveguide 11 of FIG. 1. In FIG. 3, an infrared laser light 21 emitted from the high-output type LD 1 is converged on the laser incidence end 17 of the upconvergence optical waveguide 11 via an optical system 20. Then, a rare earth ion of the core layer 12 is excited, and a visible light in a red or green band is generated by transition of an energy level. That is, laser resonance occurs in the core layer 12 to generate/output a laser light 22 in the red or green band.

FIGS. 4 to 9 are diagrams showing a procedure for manufacturing the upconvergence optical waveguide 11 of FIG. 1. FIG. 4 is a diagram showing a stacked state of the core layer 12 in a predetermined thickness on the substrate 13. A member in this state is denoted with reference numeral 30.

FIG. 5 is a diagram showing a state in which the substrate 14 is superposed and bonded onto the stacked surface of the core layer 12 of the member 30. The member in this state is denoted with reference numeral 31. The substrate 14, for example, superposed upon the member 30 is heated at a temperature in the vicinity of a transfer or softening point of the core layer 12 while pressurized, and is fusion-bonded. Alternatively, the substrate 14 is bonded to the member 30 via an organic adhesive (shown in FIG. 7 and denoted with reference numeral 35) whose optical absorption is little and whose refractive index is smaller than that of the core layer 12.

FIG. 6 is a diagram showing that the member 31 is cut in a predetermined width t1 in a direction (horizontal direction in the figure) crossing a thickness direction of the member at right angles, and a member 33 having a rectangular parallelepiped shape is cut out. As shown, the member 33 has a longitudinal direction along a cut surface. Immediately after a cutout process, the cut surface of the member 33 is rough, and therefore the sectional surface is finished by so-called optical surface polishing by techniques such as lapping.

FIG. 7 is a diagram showing a state in which the substrate 15 is bonded to the member 33. The member in this state is denoted with reference numeral 36. The substrate 15 is fusion-bonded to the member 33 via a sealing glass film 34 for the pressurizing/heating/bonding. The refractive index of the sealing glass film 34 is smaller than that of the core layer 12. Alternatively, the substrate 15 is bonded to the member 33 via the organic adhesive 35. It is to be noted that as shown in FIG. 8, the width of the core layer 12 may also be changed with respect to the longitudinal direction of the member 33.

FIG. 8 is a diagram showing a state in which the width of the core layer 12 is changed with respect to the member 33. That is, when an exposed surface 37 of the core layer 12 of the member 36 is ground or polished in the optical surface, the width of the core layer 12 can be changed. For example, the widths of the opposite ends of the core layer 12 are set to T1, T2, T1>T2 is set, and it is also possible to finish the core layer 12 in a so-called tapered shape. An excitation light is inputted into a broader end surface, and the laser light whose wavelength has been converted is taken out via a narrower end surface, so that an optical coupling efficiency of the LD to the core layer 12 is further enhanced. It is also possible to increase an excitation light density inside the core layer 12 and to enhance an output light intensity.

FIG. 9 is a diagram showing a state in which the substrate 16 is bonded to the member 36. The substrate 16 is bonded to the member 36 via the sealing glass film 34 or the organic adhesive 35. Opposite end surfaces 38, 39 of the member in this state are polished up to an optical surface level, the optical film mirror M1 is formed on the polished end surface 38, and the optical film mirror M2 is formed on the end surface 39. The upconvergence optical waveguide 11 of the first embodiment is completed through the above-described procedure.

In FIG. 9, the end surface 38 is formed on an incidence side of the excitation light, and the end surface 39 is formed on an output side of the laser light. Further in the first embodiment, a transmittance of approximately 100% with respect to the excitation light, and a reflectance of approximately 100% with respect to the wavelength-converted laser light are imparted to the optical film mirror M1. A reflectance of approximately 100% with respect to the excitation light, and a transmittance of approximately 5 to 90% with respect to the wavelength-converted laser light are imparted to the optical film mirror M2. Accordingly, a laser resonator structure is formed in the core layer 12, and the wavelength of the excitation light is converted to a shorter wavelength, and the light is outputted via the end surface 39. These optical film mirrors M1, M2 can be formed, for example, by dielectric thin films.

FIG. 10 is a flowchart showing a manufacturing process of the upconvergence optical waveguide 11 of FIG. 1. As shown in FIG. 10, first the core layer 12 is stacked on one substrate surface of the substrate 13 by thin-film forming techniques such as sputtering, CVD, and deposition (step S1). Next, the substrate 14 is superposed on a stacked surface of the core layer 12, and stacked by methods such as fusion or adhesion (step S2).

Next, the member 31 formed by the process up to the step S2 is divided into a plurality of members with a predetermined cut-out width t1 to cut out the member 33 (step S3). Next, the opposite sectional surfaces of the member 33 are polished so as to obtain optical surfaces (step S4). Next, the substrates 15, 16 are bonded to the polished surfaces of the member 33 by the methods such as fusion and adhesion (step S5).

Next, the end surfaces 38, 39 of the member formed by the process up to the step S5 in the longitudinal direction are polished so as to obtain the optical surfaces (step S6). In this manner, the optical film mirrors M1, M2 are formed on the opposite polished end surfaces (step S7).

FIG. 11 is a sectional view of the upconvergence optical waveguide 11 formed by the procedure of FIG. 10. In FIG. 11, the respective substrates 14 to 16 are bonded to the core layer 12 via optical films 41. The optical films 41 may be modified layers by the fusion of the respective substrates 14 to 16, organic adhesives 35, or thin films, for example, of magnesium fluoride (MgF2). In short, the refractive indexes of the optical films 41 surrounding the core layer 12 are set to be smaller than that of the core layer 12. Accordingly, the optical films 41 perform functions of clad layers, and the excitation light is confined in the core layer 12.

When the optical films 41 are used as the clad layers, the refractive indexes of the substrates 14 to 16 are optional. Accordingly, options of materials of the substrates 13 to 16 are broadened, and it is possible to optionally select the materials having suitable workability, weather resistance, thermal expansion, thermal conduction, and the like. Conversely, when the optical films 41 are not disposed, the function of the clad layer is imparted to the substrate that directly contacts the core layer 12. In this case, the material of the substrate forming the clad layer is restricted, and the manufacturing process can be simplified.

In this manner, in the first embodiment, the core layer 12 doped with the rare earth metals represented by lanthanum-based elements is stacked on the substrate 13 having a refractive index smaller than that of the core layer 12 by the thin-film forming techniques such as sputtering, CVD, and deposition. Next, the substrate 14 of the material similar to that of the substrate 13 is superposed and stacked on the stacked surface of the core layer 12, cut out in the predetermined width, and lapped. Furthermore, the substrates 15, 16 are bonded to the cut surfaces to form the optical waveguide in a shape of the core layer 12 having a strip shape coated with the clad layers (substrates 13 to 16). Furthermore, the optical film mirrors M1, M2 are formed on the end surfaces of the optical waveguide.

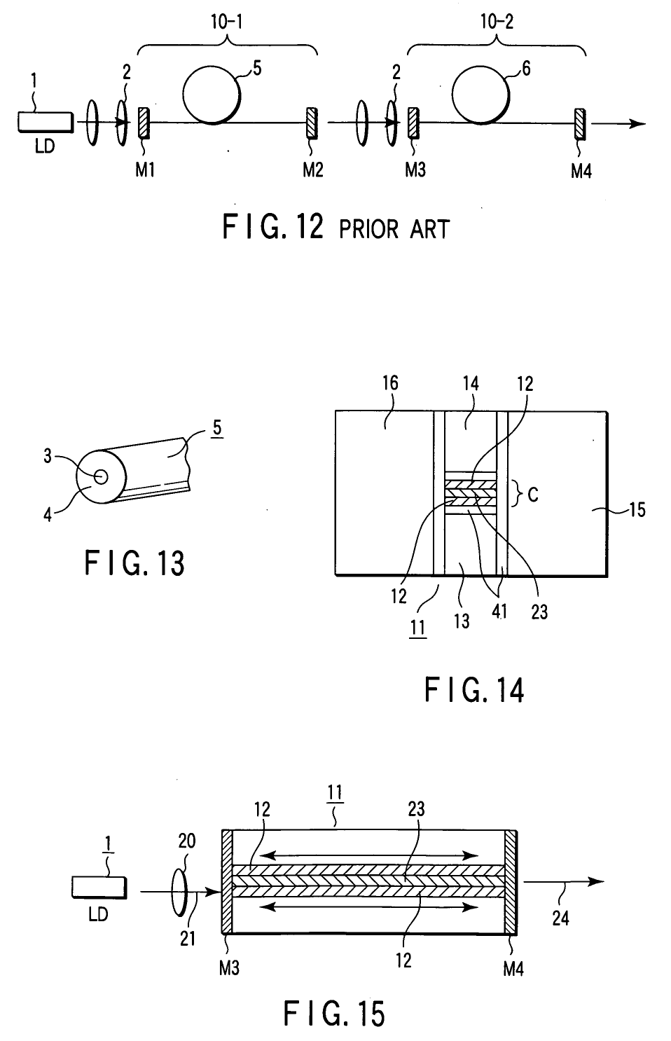

FIG. 12 is a diagram showing a conventional constitution for realizing upconvergence for comparison. In the conventional constitution, optical fibers 5, 6 to which rare earth metals are added as excitation mediums and which have a diameter of about 10 μm have been used. The optical fiber 5 is doped, for example, with Er, Pr and the like, and the optical fiber 6 is doped with thulium (Tm) and the like.

The optical film mirrors M1, M2, and optical film mirrors M3, M4 are formed on the end surfaces of the respective optical fibers 5, 6 to form laser resonators 10-1, 10-2. In FIG. 12, the laser light outputted from the high-output type LD 1 is incident upon the laser resonator 10-1 in a first stage via a non-spherical lens 2, and is up-converged. Accordingly, for example, the laser light in an infrared range is converted to a red or green range. This wavelength-converted light output is incident upon the laser resonator 10-2 in the next stage, and is further up-converged to obtain the laser light in a blue or ultraviolet range.

FIG. 13 is a schematic diagram showing a constitution of the optical fiber 5, 6. The optical fiber 5, 6 is constituted of a core 3 doped with the rare earth metals and a clad 4 which surrounds the core in an annular or columnar shape. The sectional shape is an incidence end surface shape of the laser resonator 10-1 or 10-2.

In the constitution shown in FIG. 12, the shape of the laser light emitted from the high-output type LD 1 is remarkably different from the incidence end surface shape of the laser resonator 10-1 in the first stage. Therefore, the optical coupling efficiency is deteriorated, and the loss of energy is large. The optical system having complicated mechanisms such as the non-spherical lens 2 is required, and precise optical axis alignment is necessary. This causes disadvantages that the manufacturing process becomes complicated and that the size is enlarged.

Moreover, a fluoride-based glass needs to be used in the material of the optical fiber 5 or 6 in order to enhance conversion efficiency. This type of glass represented by ZrF4-BaF2-LaF3-AlF3-NaF (ZBLAN) is very bad in weather resistance, has to be protected and used in a nitrogen (N2) atmosphere especially against humidity, and cannot be said to be convenient for use. Furthermore, this material is easily crystallized, and requires precise temperature management in forming the fiber. Therefore, the manufacturing process becomes very complicated.

On the other hand, in accordance with the first embodiment, the core layer 12 which is the excitation medium can be formed in such a manner that the shape of the incidence end surface is substantially the same as that of the laser light emitted from the high-output type LD 1 from the beginning. This rapidly enhances the optical coupling efficiency of the high-output type LD 1 to the core layer 12, and can minimize the loss of energy. Additionally, a complicated optical system is not required. That is, the optical system 20 may be simple such as a cylindrical lens, and the optical axis alignment is facilitated.

Furthermore, the upconvergence optical waveguide 11 of the first embodiment is manufactured by the processes mainly including the thin-film forming, bonding and the like, and can therefore be manufactured by a very simple procedure. Additionally, there are not any special restrictions in the shape and manufacturing procedure of the waveguide or the material and composition of the core layer 12 and substrates 13 to 16. Therefore, it is possible to select the materials principally in consideration of the emission efficiency of the core layer 12 and resistances to environments of the substrates 13 to 16.

(Second Embodiment)

Next, a second embodiment of the present invention will be described. In the first embodiment, as shown in FIG. 3, the core layer 12 is formed of a single layer film. This structure is comparable to the laser resonator 10-1 of FIG. 12, and the infrared light can be converted, for example, to a visible range of a long wavelength. Here, a mode will be described in which the infrared light can be converted further to a blue or ultraviolet range of a short wavelength through the long wavelength region.

FIG. 14 is a sectional view of the upconvergence optical waveguide 11 relating to the second embodiment. In FIG. 14, a core portion C includes a plurality of core layers 12, 23. The core layer 23 is vertically held and formed between two core layers 12. That is, the core portion C includes three sub-layers in the thickness direction.

These sub-layers are formed by a plurality of repetitions of the stacking process in the step S1 of FIG. 10. That is, after stacking the core layer 12 on one surface of the substrate 13, the core layer 23 is further stacked, and the core layer 12 is stacked on the core layer, so that the three-layer core portion C can be formed as shown in FIG. 14. The subsequent manufacturing procedure is similar to that of FIG. 10.

In the second embodiment, the refractive index of the core layer 23 of FIG. 14 is set to be larger than that of the core layer 12. Accordingly, the laser light incident upon the core portion C can be laser-oscillated in a state in which the light is confined in the core portion C. The composition of the core layer 23 is different from that of the core layer 12, and Tm and the like are added to Er and the like.

FIG. 15 is a transverse sectional view showing the function principle of the upconvergence optical waveguide 11 of FIG. 14. In FIG. 15, symbols M3, M4 denote optical film mirrors. The infrared laser light 21 incident upon the upconvergence optical waveguide 11 via the optical film mirror M3 is upconverted to a red or green band as an intermediate wavelength first in the core layer 12. The intermediate wavelength light reciprocates between the optical film mirrors M3, M4 to reach the core layer 23, and is further upconverted to ranges such as the blue or ultraviolet band.

In general, the laser light in the short wavelength range such as the blue or ultraviolet band has a high energy. Therefore, it is difficult to directly convert the wavelength of the infrared laser light in obtaining the laser light in the short wavelength range. To solve the problem, in the second embodiment, the sub-layers different in composition are stacked to form the core portion C so that so-called two-stage excitation can be performed. Accordingly, the laser light in the short wavelength range is obtained from the infrared light.

The two-stage excitation method is generally known by the constitution shown, for example, in FIG. 12. However, in FIG. 12, when the intermediate wavelength light outputted from the laser resonator 10-1 is again converged and introduced into the laser resonator 10-2, an optical coupling loss is generated, and this results in an energy loss. On the other hand, in the second embodiment, it is possible to up-convert the infrared light only in the core portion C. Therefore, the wavelength conversion requiring much energy can be realized with a high efficiency.

(Third Embodiment)

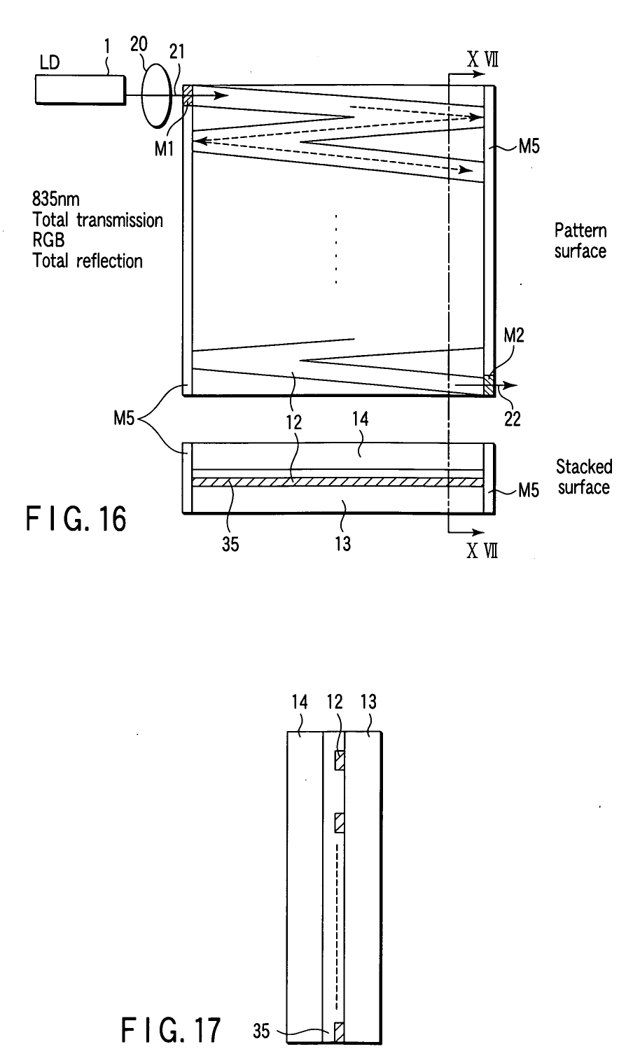

FIG. 16 is a diagram showing a third embodiment of the upconvergence optical waveguide relating to the present invention. The core layer 12 of the upconvergence optical waveguide is patterned and formed in a zigzag shape as shown by a pattern surface of FIG. 16. This pattern can be formed by a photoetching process for use in a semiconductor manufacturing technique. That is, as shown by a stacked surface of FIG. 16, the core layer 12 is stacked on the substrate 13, and an unnecessary portion is removed by the photoetching process from this state. After a desired pattern is formed, the core layer 12 is bonded to the substrate 14, for example, via the organic adhesive 35.

FIG. 17 is an XVII-XVII sectional view of the upconvergence optical waveguide of FIG. 16. When the zigzag pattern is formed, the pattern of the core layer 12 is regularly developed on the XVII-XVII section. The zigzag pattern shown in FIG. 16 is formed such that a plurality of refractive portions are exposed to the end surfaces of the substrates 13, 14. An optical film mirror M5 which total-reflects the laser light for excitation and an oscillation light is formed on the exposed surface of the refractive portion. The optical film mirror M1 is formed on the laser incidence end surface, and the optical film mirror M2 is formed on the laser emission end surface. The transmittance of the optical film mirror M1 is determined in such a manner that an infrared light having a wavelength of 835 nm is totally transmitted, and red (R), green (G), blue (B) visible lights are totally reflected. Accordingly, the laser resonator structure is formed, and the wavelength of the incident infrared laser light 21 is converted in the core layer 12 to output the laser light 22.

When the pattern shown in FIG. 16 is formed, the length of the upconvergence optical waveguide can easily be extended. That is, in the existing upconversion technique, the length of the optical fiber is sometimes several meters, but in the third embodiment, it is possible to realize this long waveguide comparatively easily.

It is to be noted that as shown in FIG. 17, the core layer 12 is a single layer film in the third embodiment, but it is possible to apply the similar manufacturing process to a case where the core layer 12 is formed in a multilayered structure as shown in FIGS. 14 and 15.

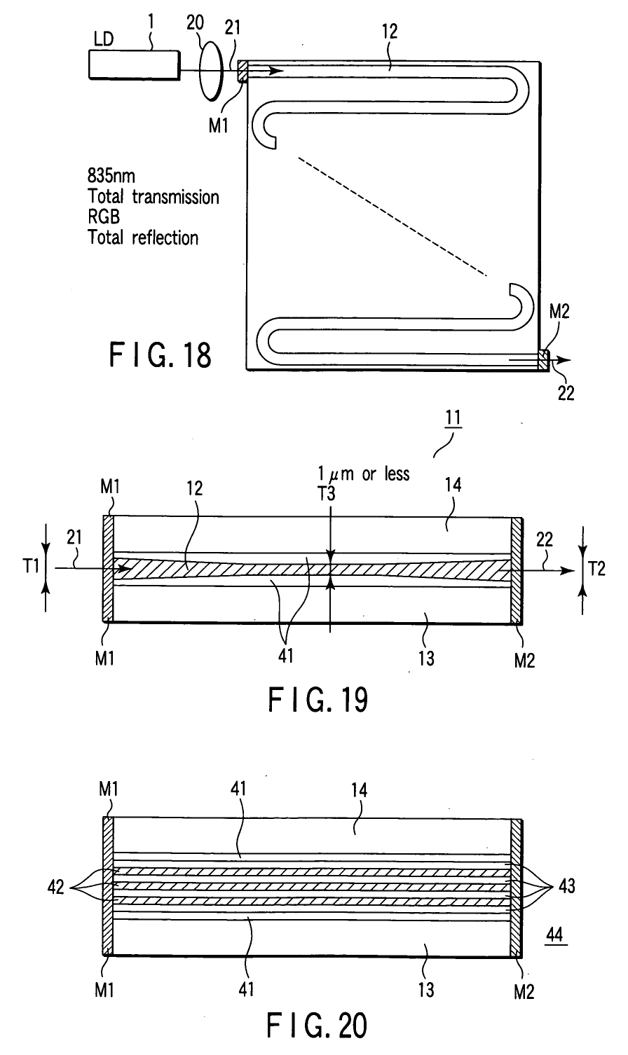

FIG. 18 is a diagram showing another example of the pattern of the core layer 12 in the third embodiment. The core layer 12 is formed in a so-called zigzag shape in this constitution. Accordingly, it is not necessary to form the mirror film on a bent portion of the pattern, and the manufacturing process can be simplified.

In accordance with the photoetching process, various other patterns such as a spiral pattern can be formed. In short, when the core layer 12 is patterned and formed in a single stroke, the length of the optical waveguide can easily be extended.

As described above, in accordance with the third embodiment, the shape of the core layer 12 can freely be determined by the photoetching process, accordingly the length of the core layer 12 can be extended in a saved size, and an efficient wavelength conversion can be realized.

As described above, in accordance with the first to third embodiments, for example, the following effects can be obtained. That is, in accordance with the first to third embodiments, a substantially rectangular core layer 12 having a shape corresponding to the emission shape of the excitation light outputted from the high-output type LD 1 can easily be formed. Therefore, as compared with the related art in which the excitation light is introduced into an upconversion fiber having a diameter of about 10 μm, it is possible to form an upconvergence optical waveguide in which a lens system can be simplified and positions are easily adjusted and an introduction efficiency of the excitation light is largely improved.

Moreover, the core layer 12 is formed by methods such as the sputtering, CVD, and deposition. Therefore, even when the materials such as fluoride glass are used, it is not necessary to consider crystallization or generation of bubbles. Similarly, a large amount of fluoride elements which have heretofore been added for a purpose of forming a fiber shape are hardly required. It is therefore possible to select a glass composition capable of most efficiently exciting the rare earth ions.

Therefore, in accordance with the first to third embodiments, it is possible to provide a light wavelength converter capable of enhancing the optical coupling efficiency to the laser source and minimizing the energy loss, and a method of manufacturing the converter. It is also possible to provide a light wavelength converter in which the restrictions on the composition are relaxed and which can be easily manufactured, and a method of manufacturing the converter.

Consequently, when measures relating to the present invention are taken, four surfaces of the excitation medium are held between the substrates, and the strip shape is formed in accordance with the thickness of the stacked layer, the width of the rectangular parallelepiped member, and the length in the longitudinal direction of the rectangular parallelepiped member. The first and second reflective members are formed on the opposite end surfaces in the longitudinal direction. When the laser light is incident upon one end surface, laser resonance occurs, and the wavelength of the laser light is converted to a shorter wavelength.

Additionally, the laser incidence end surface has a rectangular shape whose sides are the thickness of the stacked layer of the excitation medium and the width of the rectangular parallelepiped member. This is analogous to the shape of the emission surface of the semiconductor laser. Needless to say, it is possible to easily form the same shape as that of the emission surface of the semiconductor laser by adjustment of the thickness of the stacked layer of the excitation medium and the cutout width of the rectangular parallelepiped member. That is, in accordance with the present invention, it is possible to easily mold the excitation medium which is the core in a shape conforming to the emission shape of the laser light. Therefore, the optical coupling of the laser source to the light wavelength converter is rapidly enhanced without requiring any complicated optical system, and the loss of energy can easily be reduced.

Moreover, in accordance with the present invention, since the core can be formed by so-called thin-film forming techniques such as the sputtering, chemical vapor deposition (CVD), and vapor deposition, it is possible to easily proceed with the manufacturing procedure regardless of the crystallization or the generation of bubbles or without restricting the composition or the material. Accordingly, the core material having most satisfactory emission efficiency can be selected, and the wavelength conversion efficiency can further be enhanced.

Moreover, in accordance with the present invention, four surfaces of the excitation medium are held by four substrates. Accordingly, it is easy to form the reflective members on the laser light incidence end surface and emission end surface. Additionally, the weather resistance of the excitation medium is enhanced by the protection effects of the substrate and reflective member. Needless to say, since a process of forming the fiber shape is not required, the material of the substrate itself may have a higher resistance to the weather or the change with the elapse of time.

As described above in detail, in accordance with the present invention, the optical coupling efficiency to the laser source is enhanced, and it is possible to provide the light wavelength converter capable of minimizing the energy loss, and the method of manufacturing the converter. In accordance with the present invention, it is also possible to provide the light wavelength converter in which the restrictions on the composition are relaxed and which can be easily manufactured, and the method of manufacturing the converter.

It is to be noted that the present invention is not limited to the first to third embodiments.

FIG. 19 is a diagram showing the upconvergence optical waveguide 11 relating to another embodiment of the present invention. In FIG. 19, the upconvergence optical waveguide 11 is shown whose sectional shape (or width or thickness) is changed in the longitudinal direction of the core layer 12. This mode can be realized by the thin-film forming process or the lapping process. That is, the thickness or the width of the shape of the core layer 12 may also be gradually reduced to a middle part from an introduction side of the excitation light or a take-out side of the emission laser. In this case, the optical coupling efficiency and the take-out efficiency of the laser light are easily enhanced. Moreover, the excitation light density in the core layer 12 can be increased to further enhance the wavelength conversion efficiency.

FIG. 20 is also a diagram showing the upconvergence optical waveguide 11 relating to another embodiment of the present invention. In FIG. 20, fluoride films 43 containing oxides such as SiO2 and fluoride films 42 doped with the rare earth metals such as Pr, Eb, Tm are alternately stacked to form a multilayered film. The multilayered film is held between the substrates 13, 14 via the optical films 41 which constitute the clad layers. Accordingly, a glass film 44 is formed.

In FIG. 20, the emitted light is propagated in the oxide films such as SiO2 or the fluoride films 43 broad in a non-absorption band. The optical films 41 are formed of materials having low refractive indexes, such as MgF2.

With this constitution, it is possible to form all the films by single element or two or three elements. Accordingly, the composition can be prevented from being easily changed or diffracted during the forming of a rare earth added glass film. It is also possible to keep a satisfactory transmittance with little light absorption over far infrared and ultraviolet ranges. That is, the deterioration of the transmittance and the increase of the absorption can be inhibited, and this is especially advantageous in obtaining a high-output ultraviolet laser light. In FIG. 20, the fluoride film 42 can be formed by a composition highest in laser emission efficiency. That is, it is not necessary to consider factors which are not directly related to the laser emission efficiency, such as the weather resistance.

Furthermore, in the first to third embodiments, the composition of the core layer 12 is not limited to the fluoride glass doped with the rare earth metals. The core layer 12 may also be formed using a more general glass material such as oxide.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light wavelength converter including an excitation medium doped with rare earth metals to convert a wavelength of a laser light incident upon the excitation medium, comprising:
a rectangular parallelepiped member comprising a layered member in which the excitation medium is stacked in films on a first optical member having a refractive index lower than that of the excitation medium and having a flat plate shape and in which a second optical member having a refractive index lower than that of the excitation medium is stacked on the stacked surface of the first optical member;
third and fourth optical members which are bonded onto surfaces extending in parallel with a longitudinal direction of the rectangular parallelepiped member and crossing the stacked surface at right angles and which have a refractive index lower than that of the excitation medium; and
first and second reflective members which are formed on the opposite end surfaces of the rectangular parallelepiped member in the longitudinal direction to form a laser resonator structure.

2. The light wavelength converter according to claim 1, wherein the excitation medium comprises a plurality of sub-layers having different refractive indexes with respect to a thickness direction of the layered member.

3. The light wavelength converter according to claim 2, wherein the plurality of sub-layers include a sub-layer on which the laser light is incident and which has a lowest refractive index, and the other sub-layers have a refractive index successively increasing stepwise from a sub-layer stacked adjacent to the sub-layer upon which the laser light is incident.

4. The light wavelength converter according to claim 1, wherein the third and fourth optical members are fusion-bonded to the rectangular parallelepiped member.

5. The light wavelength converter according to claim 1, wherein the third and fourth optical members are bonded to the rectangular parallelepiped member via an adhesive having a refractive index lower than that of the excitation medium.

6. The light wavelength converter according to claim 1, wherein excitation medium is stacked on the first optical member by a thin-film forming technique.

7. The light wavelength converter according to claim 1, wherein a sectional area of the excitation medium changes with respect to a longitudinal direction of the rectangular parallelepiped member.

8. A light wavelength converter including an excitation medium doped with rare earth metals to convert a wavelength of a laser light incident upon the excitation medium, comprising:
a first optical member having a refractive index lower than that of the excitation medium and having a flat plate shape;
an optical waveguide formed by the excitation medium patterned in a zigzag shape having a plurality of refractive portions on one plate surface of the first optical member;
a second optical member which is stacked on the optical waveguide via a bonding member having a refractive index lower than that of the excitation medium and which has a refractive index lower than that of the excitation medium; and
a reflective portion forming a laser resonator structure in which the laser light incident upon the excitation medium is reflected in the plurality of refractive portions.

9. A light wavelength converter including an excitation medium doped with rare earth metals to convert a wavelength of a laser light incident upon the excitation medium, comprising:
a first optical member having a refractive index lower than that of the excitation medium and having a flat plate shape;
an optical waveguide formed by the excitation medium patterned in a single stroke on one plate surface of the first optical member;
a second optical member which is stacked on the optical waveguide via a bonding member having a refractive index lower than that of the excitation medium and which has a refractive index lower than that of the excitation medium; and
reflective portions which are formed on opposite ends of the excitation medium to form a laser resonator structure which reflects the laser light incident upon the excitation medium.

10. The light wavelength converter according to claim 9, wherein the excitation medium is formed in a zigzag shape.

11. The light wavelength converter according to claim 9, wherein the excitation medium is formed in a spiral shape.

12. The light wavelength converter according to claim 8 or 9, wherein the excitation medium is stacked on one plate surface of the first optical member by a photoetching process.

13. A method of manufacturing a light wavelength converter including an excitation medium doped with rare earth metals to convert a wavelength of a laser light incident upon the excitation medium, the method comprising:
a first step of stacking the excitation medium in a film on a first optical member having a refractive index lower than that of the excitation medium and having a flat plate shape;
a second step of stacking a second optical member having a refractive index lower than that of the excitation medium on the stacked surface of the excitation medium to form a layered member;
a third step of cutting the layered member with a predetermined width in a direction crossing a thickness direction of the layered member at right angles to form a rectangular parallelepiped member having a longitudinal direction;
a fourth step of polishing the opposite cut surfaces of the rectangular parallelepiped member in optical surfaces;
a fifth step of bonding third and fourth optical members having a refractive index lower than that of the excitation medium onto the opposite cut surfaces of the polished rectangular parallelepiped member;
a sixth step of polishing the opposite end surfaces of the rectangular parallelepiped member in the optical surfaces; and
a seventh step of bonding first and second reflective members forming a laser resonator structure onto the opposite end surfaces of the polished rectangular parallelepiped member in the longitudinal direction.

14. The method of manufacturing the light wavelength converter according to claim 13, wherein the first step comprises: a step of stacking a plurality of excitation mediums having different refractive indexes with respect to the thickness direction of the layered member.

15. The method of manufacturing the light wavelength converter according to claim 14, wherein the first step comprises: successively changing the refractive indexes of the plurality of excitation mediums stepwise for each adjacent excitation medium to stack the plurality of excitation mediums.

16. The method of manufacturing the light wavelength converter according to claim 13, wherein the fifth step comprises: fusion-bonding the third and fourth optical members onto the rectangular parallelepiped member.

17. The method of manufacturing the light wavelength converter according to claim 13, wherein the fifth step comprises: bonding the third and fourth optical members onto the rectangular parallelepiped member via an adhesive having a refractive index lower than that of the excitation medium.

18. The method of manufacturing the light wavelength converter according to claim 13, wherein the first step comprises: stacking the excitation medium on the first optical member by a thin-film forming technique.

19. The method of manufacturing the light wavelength converter according to claim 13, wherein the first step comprises: an eighth step of forming the excitation medium in such a manner that a sectional area of the excitation medium in a middle part of the rectangular parallelepiped member in the longitudinal direction is broader than that of the excitation medium in an end of the rectangular parallelepiped member in the longitudinal direction.

20. A method of manufacturing a light wavelength converter including an excitation medium doped with rare earth metals to convert a wavelength of a laser light incident upon the excitation medium, the method comprising:
a first step of patterning the excitation medium in a zigzag shape having a plurality of refractive portions to form an optical waveguide on one plate surface of a first optical member having a refractive index lower than that of the excitation medium;
a second step of stacking a second optical member having a refractive index lower than that of the excitation medium on the optical waveguide via a bonding member having a refractive index lower than that of the excitation medium; and
a third step of forming a reflective portion forming a laser resonator structure which reflects the laser light incident upon the excitation medium in the plurality of refractive portions.

21. A method of manufacturing a light wavelength converter including an excitation medium doped with rare earth metals to convert a wavelength of a laser light incident upon the excitation medium, the method comprising:
a first step of patterning the excitation medium in a single stroke to form an optical waveguide on one plate surface of a first optical member having a refractive index lower than that of the excitation medium;
a second step of stacking a second optical member having a refractive index lower than that of the excitation medium on the optical waveguide via a bonding member having a refractive index lower than that of the excitation medium; and
a third step of forming reflective portions forming a laser resonator structure which reflects the laser light incident upon the excitation medium on opposite ends of the excitation medium.

22. The method of manufacturing the light wavelength converter according to claim 20 or 21, wherein the first step comprises: stacking the excitation medium on one plate surface of the first optical member by a photoetching process.
